(19) United States
(12) Patent Application Publication
(10) Pub. No.: US 2022/0266363 A1
(43) Pub. Date: Aug. 25, 2022

(54) HUMAN-BODY-DEFINED SECURITY RECOGNITION SYSTEM OF PROCESSING MACHINE

(71) Applicant: NAN JOHN ELECTRICAL CO., LTD., TAINAN CITY (TW)

(72) Inventor: Shiuh-Yau LIANG, TAINAN CITY (TW)

(21) Appl. No.: 17/184,600

(22) Filed: Feb. 25, 2021

(51) Int. Cl. B23D 59/00; G06K 9/00; G06F 3/041; G06F 3/14

(52) U.S. Cl. CPC B23D 59/008; G06K 9/00362; G06F 3/041; G06F 3/14

(57) ABSTRACT

A human-body-defined security recognition system of a processing machine is provided. The processing machine includes an electric driving device, a transmission portion, and a processing portion and a cutting tool. The processing machine is connectable with a security recognition system that is operable to define a human body. The security recognition system includes a central processing unit in connection with an input device and a display element. The central processing unit is connected with a camera device corresponding to the cutting tool and includes a terminal connectable with the electric driving device. The central processing unit uses a positional image of the cutting tool captured by the camera device and vicinity of the cutting tool defined by the input device to plan a security recognition zone. Upon identifying the entry of a human body into the security recognition zone, time central processing unit shuts down the electric driving device.

### TECHNICAL FIELD OF THE INVENTION

The present invention relates to a human-body-defined security recognition system of a processing machine, which involves technology in which the security recognition system sets up a security recognition zone using a camera device in order to eliminate potential risks caused on a human body entering the security recognition zone.

### DESCRIPTION OF THE PRIOR ART

As shown in FIGS. 1, 2, and 3, which are respectively a schematic view showing a known machine tool, another schematic view showing a known machine tool, and a schematic front view showing a protection device of a known machine tool A machine tool 20 is provided for processing a wood workpiece 10. Generally, to process the wood workpiece 10 with the machine tool 20, hands A0 are used to feed the wood workpiece 10 to a cutting tool 201 for proceeding with cutting and processing (as shown in FIG. 1), or alternatively the hands A0 operate a handheld cutting tool 202 to contact the wood workpiece 10 that is put in rotation to proceed with cutting (as shown in FIG. 2).

Thus, it is common that the operation of the machine tool 20 is based on using hands A0 to control the wood workpiece 10, and this implies the hands A0 and the human body A01 are constantly exposed to dangers of contacting with and being dragged resulting from the mechanical energy of the machine tool 20, as shown in FIGS. 1 and 2. Consequently, the machine tool 20 often includes, as an expansion thereof, a protection device 30 that is operable to instantly stop the operation of the cutting tool 201. Due to human body A01 constantly carrying electric charges, when the human body A01 approaches the cutting tool 201, the electric charges of the human body A01 instantaneously trigger the protection device 30 to powerfully pinch and thus stop the cutting tool 201 in order to protect all parts of the human body A01 and the hands A.01 from being hurt by the cutting tool 201 that is being in operation (see FIG. 3).

However, the cutting tool 201, once being pinched, would become scrapped and a now one must be purchased for replacement. The installation cost of the protection device 30 is high and this makes wood workshops less interested in installation of such a protection device 30. As a consequence, the protection device 30 is not prevailing and the true value of the protection device is not appreciated (as shown in FIG. 3).

### SUMMARY OF THE INVENTION

In the present invention, a processing machine comprises an electric driving device. The electric driving device drives a transmission portion. The transmission portion is connected with a processing portion. The processing portion is provided with a cutting tool that is drivable by the transmission portion. The processing machine is connectable with a security recognition system that is operable to define a human body. The security recognition system comprises a central processing unit. The central processing unit is connected with an input device and a display element. The central processing unit is connected with a camera device that is arranged to correspond to the cutting tool. The central processing unit comprises a terminal that is connectable with the electric driving. The central processing unit is operable to plan a security recognition zone that a human body is not allowed to enter based on a positional image of the cutting tool photographed by the camera device according to vicinity of the cutting tool defined by means of the input device. Upon identifying entry of the human body into the security recognition zone, the central processing unit stops operations of the electric driving device and the cutting tool and makes displaying on the display element.

The central processing unit according to the present invention is connectable with a brake portion disposed on the transmission portion. The brake portion comprises a power element. The power element comprising a braking element that is selectively operable to stop and jam the transmission portion. Further, the display element can be a touch screen, In addition to the security recognition system, a human body security recognition wearable piece is provided for being worn by the human body and being detectable and identified by the central processing unit such that the central processing unit may recognize, through detection of the human body security recognition wearable piece, whether the human body is in the security recognition zone.

The human body security recognition wearable piece is provided, on a surface thereof, with a recognizable object that is detectable and identifiable by the central processing unit such that the central processing unit may recognize, through detection of the recognizable object on the human body security recognition wearable piece, whether the human body is in the security recognition zone.

The primary objective of the present invention is that the central processing unit of the security recognition system is connected, through the terminal, to the processing machine, and the camera device is arranged to correspond to the cutting tool of the processing machine. The central processing unit plans and determines the security recognition zone based on an image captured or photographed by the camera device according to vicinity of the cutting tool defined by means of the input device and a computer mouse. The security recognition zone of the processing machine is displayed on the screen so as to achieve an effect that the security recognition zone could provide effective monitoring of the cutting tool of the processing machine.

Another objective of the present invention is that the central processing unit of the security recognition system uses the camera device and the security recognition zone to achieve effectively monitoring a condition of operation of the cutting tool of the processing machine to achieve an effect that the central processing unit drives the braking element to stop and jam operations of the transmission portion and the cutting tool.

A further objective of the present invention is that the central processing unit of the security recognition system uses the camera device to achieve an effect of effectively recognizing entry of the recognizable object into the security recognition zone.

### BRIEF DESCRIPTION OF THE DRAWINGS

FIG. 1 is a schematic view showing a known machine tool.

FIG. 2 is another schematic view showing a known machine tool.

FIG. 3 is a schematic front view showing a protection device of a known machine tool.

FIG. 4 is a schematic side view showing a processing machine and a security recognition system according to the present invention.

FIG. 5 is a schematic view demonstrating use of the processing machine and the security recognition system according to the present invention.

FIG. 6 is a schematic view demonstrating another use of the security recognition system according to the present invention.

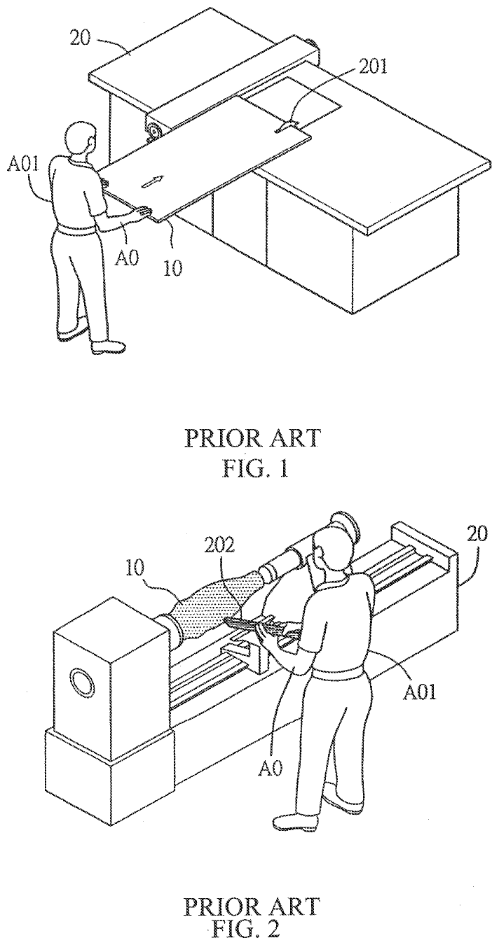

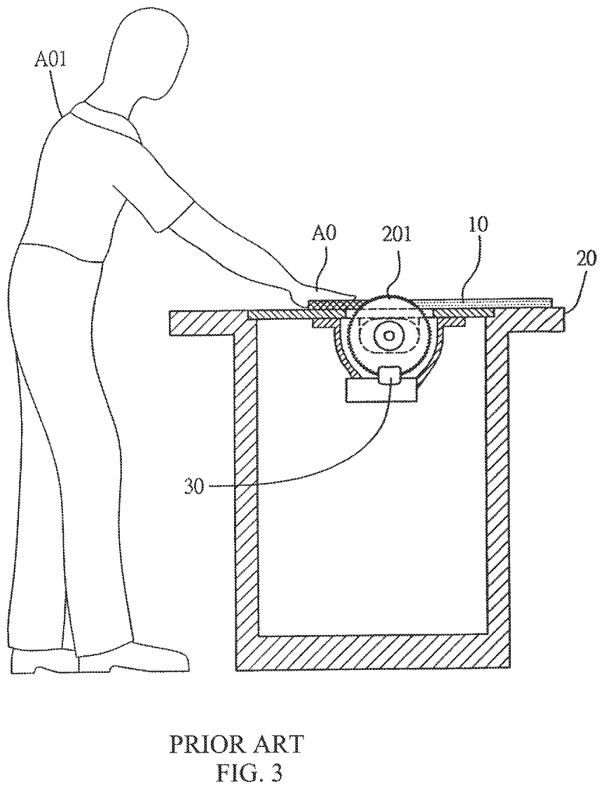

### DETAILED DESCRIPTION OF THE PREFERRED EMBODIMENT

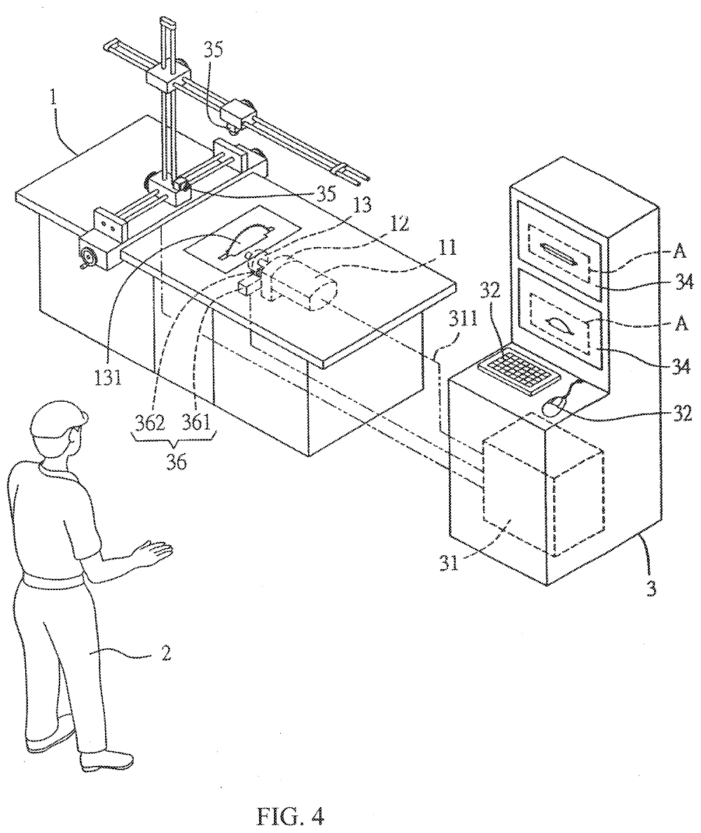

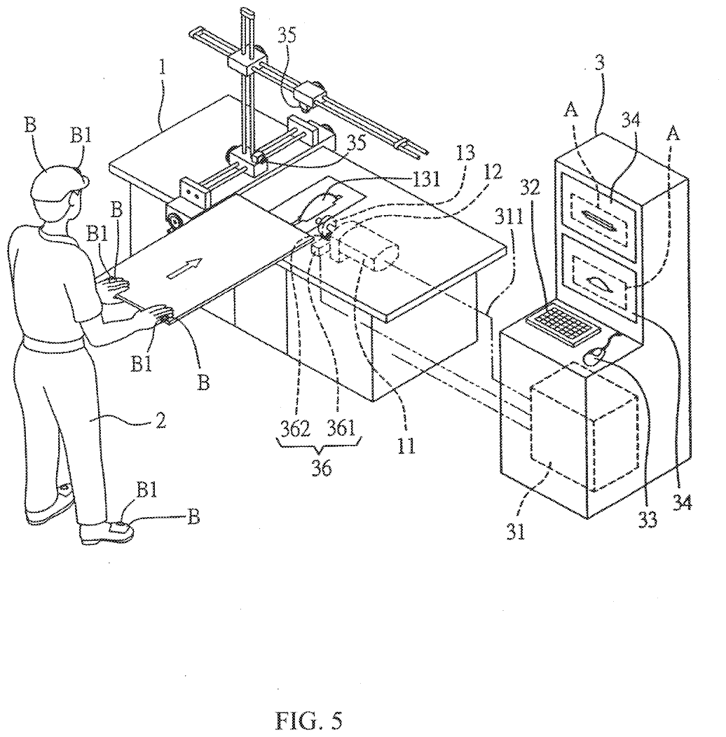

Referring to FIGS. 4, 5, and 6, which are respectively a schematic side view showing a processing machine and a security recognition system according to the present invention, a schematic view demonstrating use of the processing machine and the security recognition system according to the present invention, and a schematic view demonstrating another use of the security recognition system according to the present invention, the present invention provides a human-body-defined security recognition system of the processing machine The processing machine 1 at least comprises an electric driving device 11. The electric driving device 11 at least drives a transmission portion 12. The transmission portion 12 is at least connected to a processing portion 13. The processing portion 13 comprises a cutting tool 131 that is driven by the transmission portion 12. The processing machine 1 is at least connectable with a security recognition system 3 that establishes definition of a human body 2, The security recognition system 3 at least comprises a central processing unit 31. The central processing unit 31 is at least connectable to an input device 32 and at least one display element 34. The central processing unit 31 is connected with a camera device 35 that is arranged to correspond to the cutting tool 131. The central processing unit 31 at least comprises a terminal 311 that is connectable with the electric driving device 11. The central processing unit 31 is operable to plan or determine a security recognition zone A that a human body 2 is not allowed to enter or is supposed not to enter based on a positional image of the cutting tool 131 captured or photographed by the camera device 35 according to vicinity of the cutting tool 131 defined by means of the input device 32, such that the central processing unit 31, upon identifying entry of the human body 2 into the security recognition zone A, immediately shuts down and stops the electric driving device 11 and the cutting tool 131 and makes related displaying on the display element 34. Further, the processing machine is not limited to a processing machine 1 for carpentry, and the processing machine 1 can be used in combination with processing machines of various fields that require installation of the security recognition system 3 for collaborative operation therewith (see FIGS. 4 and 5).

The central processing unit 31 according to the present invention is at least connectable with a brake portion 36 disposed on the transmission portion 12. The brake portion 36 at least comprises a power element 361. The power element 361 comprises a braking element 362 that is selectively drivable to stop and jam the transmission portion 12. Further, the display element 34 can be a touch screen(as shown in FIGS. 4 and 5). In addition to and outside the security recognition system A, a human body security recognition wearable piece B is provided for being worn by the human body 2 to be detected and identified by the central processing unit 31 within the security recognition zone A. The human body security recognition wearable piece B is provided, for example on a surface thereof, with a recognizable object B1 that is detectable and identifiable by the central processing unit 31 such that the central processing unit 31 may recognize, through detection of the recognizable object B1 on the human body security recognition wearable piece B, whether the human body is in the security recognition zone A (as shown in FIG. 5).

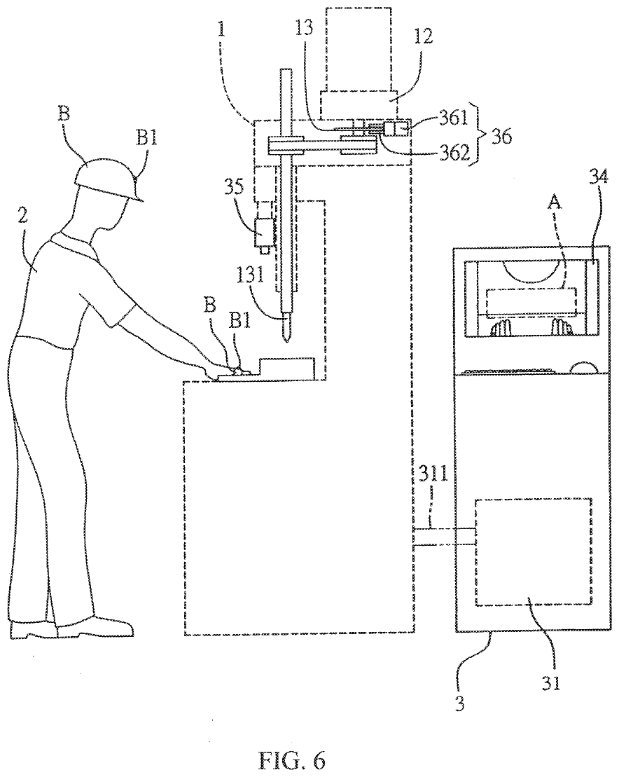

Thus, the security recognition system 3 according to the present invention uses the central processing unit 31 to recognize the human body 2 entering the security recognition zone A, such that upon entry of the human body 2 into the security recognition zone A, the central processing unit 31 signals through the terminal 311 to activate or shut down the electric driving device 11 and the cutting tool 131 and also to drive the power element 361 to stop and jam the transmission portion 12 by means of the braking element 362. Further, the recognizable object B1 enhances or strengthens the effect of detection and identification of a part of the human body 2 by the central processing unit 31. As such, the human body 2, who enters the security recognition zone A, is protected from contacting the cutting tool 131 in all circumstances (as shown in FIGS. 5 and 6).

One can appreciate from the above description that the central processing unit 31 of the security recognition system 3 according to the present invention is connectable, through the terminal 311, to the electric driving device 11; the cutting tool 131 driven by the electric driving device 11 is provided with the camera device 35; and the central processing unit 31 plans and determines the security recognition zone A that a human body 2 is not allowed to enter based on a positional image of the cutting tool 131 captured or photographed by the camera device 35 according to vicinity of the cutting tool 131 defined by means of the input device 32, wherein the security recognition zone A is displayed on the display element 34 to allow for effective monitoring the human body 2 approaching the cutting tool 131 by means of the security recognition zone A to achieve an effect that the central processing unit 31 signals to shut down the electric driving device 11 upon the entry of the human body 2 into the security recognition zone A. This is the primary advantageous feature of the present invention.

The central processing unit 31 of the security recognition system 3 according to the present invention uses the camera device 35 and the security recognition zone A to achieve effective monitoring a condition of operation of the cutting tool 131 so as to achieve an effect that the central processing unit 31 signals to drive the power element 361 to stop and jam the operation of the transmission portion 12 by means of the braking element 362 upon the entry of the human body 2 into the security recognition zone A. This is another advantageous feature of the present invention.

The central processing unit 31 of the security recognition system 3 according to the present invention uses an image captured by the camera device 35 to identify the recognizable object B1 worn on the human body 2 entering the security recognition zone A, so as to achieve an effect that the central processing unit 31 signals to drive the power element 361 to stop and jam the operation of the transmission portion 12 by means of the braking element 362 upon the entry of the recognizable object B1 into the security recognition zone A. This is a further advantageous feature of the present invention.

I claim:

1. A human-body-defined security recognition system of a processing machine, wherein the processing machine at least comprises an electric driving device, the electric driving device being operable to at least drive a transmission portion, the transmission portion being at least connected with a processing portion, the processing portion comprising a cutting tool that is drivable by the transmission portion, the processing machine at least being connectable with a security recognition system that is operable to define a human body, the security recognition system at least comprising a central processing unit, the central processing unit being at least connected with an input device and at least a display element, the central processing unit being connected with a camera device that is arranged to correspond to the cutting tool, the central processing unit at least comprising a terminal that is connectable with the electric driving, the central processing unit being operable to plan a security recognition zone that a human body is not allowed to enter based on a positional image of the cutting tool photographed by the camera device according to vicinity of the cutting tool defined by means of the input device, wherein upon identifying entry of the human body into the security recognition zone, the central processing unit stops operations of the electric driving device and the cutting tool and makes displaying on the display element.

2. The human-body-defined security recognition system according to claim 1, wherein the central processing unit is at least connectable with a brake portion disposed on the transmission portion, the brake portion at least comprising a power element, the power element comprising a braking element that is selectively operable to stop and jam the transmission portion, the display element selectively comprising a touch screen.

3. The human-body-defined security recognition system according to claim 1, wherein in addition to the security recognition system, a human body security recognition wearable piece is wearable by the human body to be detectable and identified by the central processing unit such that the central processing unit recognizes, through detection of the human body security recognition wearable piece, the human body is in the security recognition zone.

4. The human-body-defined security recognition system according to claim 2, wherein the human body security recognition wearable piece is provided, on a surface thereof, with a recognizable object that is detectable and identifiable by the central processing unit such that the central processing unit recognizes, through detection of the recognizable object on the human body security recognition wearable piece, the human body is in the security recognition zone.
